(19) United States
(12) Patent Application Publication
(10) Pub. No.: US 2005/0216319 A1
(43) Pub. Date: Sep. 29, 2005

(54) Retail stamp with tracking

(76) Inventor: Gary C. Reblin, Falls Church, VA (US)

Correspondence Address: FINNEGAN, HENDERSON, FARABOW,;GARRETT & DUNNER, L.L.P., 1300 I Street, N.W., Washington, DC, 20005, US

(21) Appl. No.: 10/953,272

(22) Filed: Sep. 30, 2004

Related U.S. Application Data
(60) Provisional application No. 60/549,909, filed on Mar. 5, 2004.

(51) Int. Cl. G06F 17/60

(52) U.S. Cl. 705/6

(57) ABSTRACT

Systems and methods allow a customer to determine a delivery status for a delivery item having an affixed delivery fee indicator such as a retail postage stamp, using a unique identifier associated with the delivery fee indicator, such as a unique barcode on a retail postage stamp.

### RELATED APPLICATIONS

This application is related to and claims priority of U.S. Provisional Application No. 60/549,909 entitled “Retail Stamp Track and Trace” filed Mar. 5, 2004, which is incorporated herein by reference in its entirety.

### TECHNICAL FIELD

This invention relates generally to a system and method for tracking delivery items, and more particularly, to a system and method for providing tracking services for delivery items through unique identifiers on delivery fee indicators.

### BACKGROUND

Presently, customers of delivery service providers, such as the United States Postal Service (USPS), United Parcel Service, or Federal Express, may ship delivery items using labels that indicate payment of delivery fees. For example, the USPS sells retail postage stamps to its customers. The customers affix the stamps to mail pieces prior to depositing them with the USPS for delivery.

During processing for delivery, a number of different types of automated equipment may handle the delivery item. The automated equipment includes a number of commercially available machines, such as a delivery barcode sorter, a carrier sequence barcode sorter, and other barcode equipment. The automated equipment also may include optical character recognition (OCR) equipment. This equipment is capable of reading information, such as a unique identifier, for each delivery item.

Despite the fact that so many devices can read such information, the information is not readily available to customers wanting to know the delivery status or present location of a delivery item. Thus, it is desirable to provide delivery fee indicators having a unique identifier, and a tracking service for delivery items containing such indicators, so that information regarding the delivery status is readily available to the customer.

### SUMMARY

Consistent with the invention, systems and methods for tracking delivery items comprise a delivery fee indicator having a unique identifier that identifies the delivery item to which the indicator is affixed.

Also included is a method for tracking delivery items, comprising the step of generating a unique identifier for each delivery fee indicator to uniquely identify the item to which the indicator is affixed.

It is to be understood that both the foregoing general description and the following detailed description are exemplary and explanatory only and are not restrictive of the appended claims.

The accompanying drawings, which are incorporated in and constitute a part of this specification, illustrate an embodiment of the invention and together with the description, serve to explain the principles of the invention.

### BRIEF DESCRIPTION OF THE DRAWINGS

FIG. 1 illustrates a delivery fee indicator consistent with the present invention.

FIG. 2 illustrates a system consistent with the invention for tracking a delivery item having an affixed delivery fee indicator.

FIG. 3 is a flowchart illustrating a method consistent with the invention for tracking a delivery item having an affixed delivery fee indicator.

### DESCRIPTION OF THE EMBODIMENTS

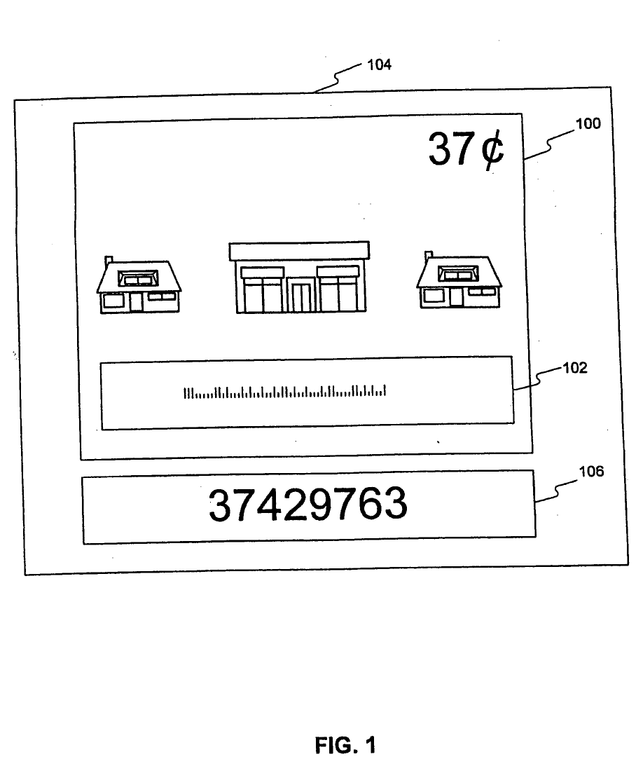

FIG. 1 is an illustration of a delivery fee indicator in the form of a retail postage stamp 100 having a unique identifier 102. As illustrated, the unique identifier 102 may be embedded in a barcode, for example a two-dimensional barcode, that is printed directly on the postage stamp 100. Stamp 100 may be provided, for example, in a peel-off form on a substrate 104 or produced on demand from a printer and affixed to a delivery item, such as a mailpiece.

In addition, a human-readable form 106 of the unique identifier may be located on the postage stamp. For example, the unique identifier in human-readable form 106 may be located directly below the stamp on substrate 104 in a peel-off design, as shown in FIG. 1, so that the customer may enter the unique identifier in a checkbook, notebook, or other tracking administration system to record the unique identifier of the mailpiece. Alternatively, a human-readable form of the unique identifier may be printed underneath each stamp on substrate 104 so that the customer retains the human-readable form of the unique identifier for his records. Also, a human-readable form of the unique identifier may be located on a separate sheet having an associated blank field allowing the customer to record information associated with the sent mailpiece.

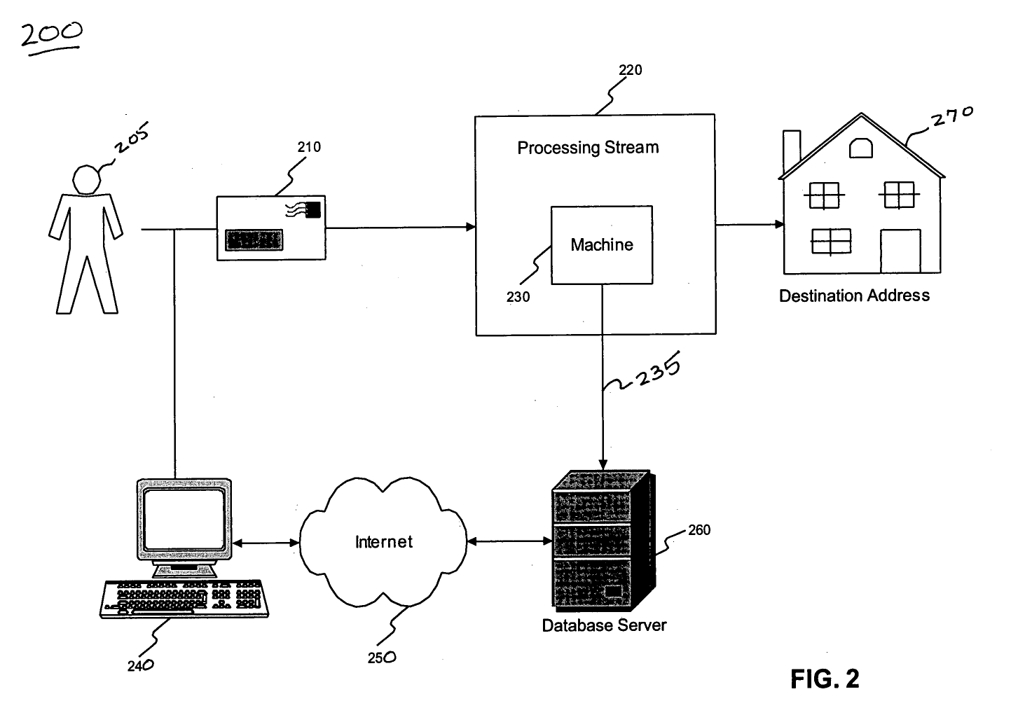

FIG. 2 illustrates a system 200 consistent with the invention for tracking a delivery item having an affixed delivery fee indicator.

In an exemplary embodiment of a system of the invention, customer 205 affixes a delivery fee indicator, such as a retail postage stamp, to a delivery item 210, such as First Class mail. The retail postage stamp includes a unique identifier. The delivery item 210 is received by the delivery service provider 220 for automated delivery processing via delivery machines 230, such as barcode sorters. A reader in at least one delivery machine 230 reads the unique identifier of the delivery item 210 while it processes the delivery item 210. A signal generator or transmitter of the machine 230 transmits a status signal 235 containing the unique identifier and status information including the processing status of the delivery item 210. A database, for example on a database server 260, receives the status signal 235 and stores the status information together with the unique identifier. A query system, such as a personal computer 240 accessing the database via the internet 250, receives a customer-generated status inquiry (e.g., via computer 240) including the unique identifier of the delivery item 210. The query system queries the database to retrieve the status information using the unique identifier. The query system then transmits the status information to the customer.

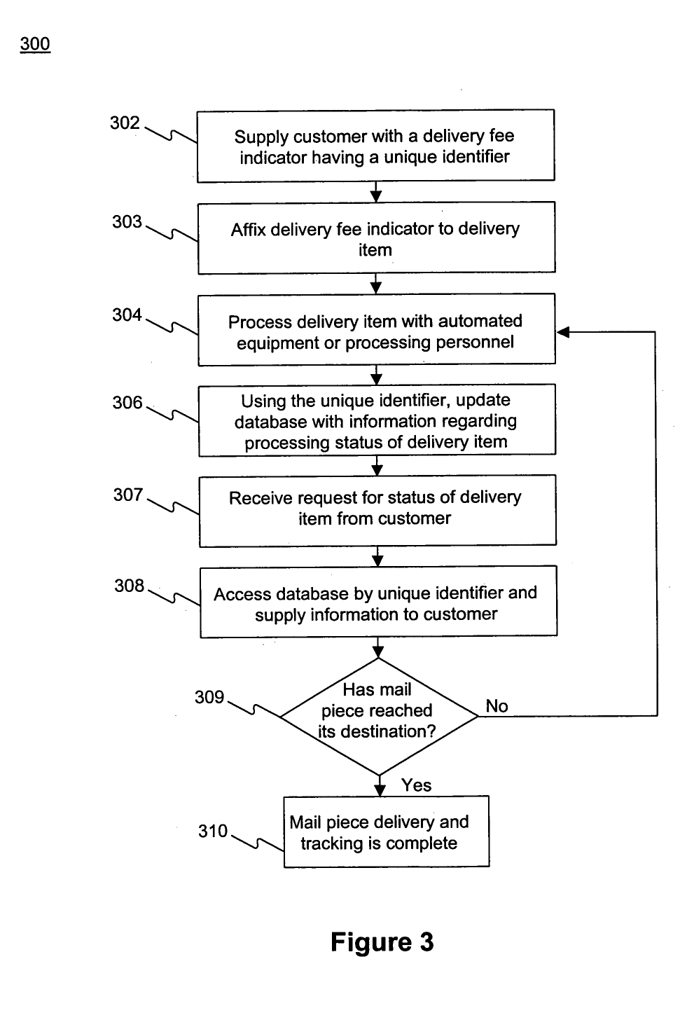

FIG. 3 is a flowchart of a method 300 for tracking a delivery item containing a delivery fee indicator.

Method 300 begins at stage 301 when the shipping service provider supplies the customer with a delivery fee indicator, such as a retail postage stamp, having a unique identifier. The stamp can be sold individually or in a booklet at retail to the customer. The unique identifier can be embedded in a two-dimensional barcode, as shown in FIG. 1. At stage 302, the customer affixes the retail postage stamp to the mailpiece.

At stage 303, the shipping service provider receives the mailpiece having the affixed retail stamp with a unique identifier. The unique identifier allows tracking of the mailpiece during processing through a distribution network operated by shipping service provider, as explained below.

At stage 304, the mailpiece is processed by either an automated piece of equipment or by mail processing personnel. Typically, a series of automated equipment or personnel at one or more locations perform designated tasks until the mailpiece is delivered to a desired destination.

At stage 306, when the mailpiece is handled by one of the automated pieces of equipment or mail processing personnel, the identifier is read from the stamp and associated with other data, such as location of the processing stage and time. Preferably, the reading takes place by an automated scan of the stamp on mailpieces. A database is then automatically updated with the unique identifier and associated data to form a data record for the mailpiece and associate the unique identifier with the mailpiece. The record may also contain other information associated with the mailpiece, and may include information obtained by other means. Updates may occur at each processing point, or at only selected points. The database contains information on a plurality of mailpieces handled by the shipping service provider. Therefore, the database can be accessed to provide the location or processing status of the mailpiece by entering the mailpiece's unique identifier as supplied by the affixed stamp.

This method of tracking the mailpiece is a passive method that does not require the use of steps or equipment beyond that which is already utilized in mailpiece processing. Additional barcode scanners and scanning steps need not be added to the existing delivery process.

At stage 307, a mailpiece status request, including the unique identifier, is received from the customer (e.g., a sender or receiver of the mailpiece). The request may be received via a website, e-mail, phone or other appropriate means. In response to the request, at stage 308, the database is accessed and status information regarding the mailpiece is provided to the customer. Alternatively, the status of one or more trackable mailpieces can be sent to the customer at predetermined intervals, without the customer having to request the information. The status information may include information identifying a piece of equipment that processed the mailpiece and its location, indicating that the mailpiece is in transit (e.g., on a plane to a destination processing center), or identifying that the mailpiece is ready for delivery (e.g., a mail carrier is in the process of delivering the mailpiece). Preferably, the customer may access the database at any time during method 300.

At stage 309, if the mailpiece needs to undergo further processing (i.e., it has not yet been delivered), method 300 returns to stage 304 and completes the steps as described above. If no further processing is required for delivery of the mailpiece, the mail delivery and tracking are complete at stage 310.

In an alternative embodiment, a container that carries the delivery item may alternatively or additionally be tracked. For example, using the system and method outlined above, the customer supplies a delivery item to the delivery service provider, the delivery item having a delivery fee indicator with a unique identifier such as a two-dimensional barcode. Once the customer gives the item to a delivery service provider for delivery, the item may be placed into a container that carries a plurality of delivery items. The container has its own unique identifier such as a two-dimensional barcode or a radio-frequency identifier (RFID). Personnel at the processing center associate the delivery item unique identifier with the container's unique identifier. The delivery item may then be tracked using the container's unique identifier instead of the unique identifier of the delivery item. Preferably, the customer continues to track the delivery item by its unique identifier, and never needs to be aware of the unique identifier of the container. For the processing center, this allows for efficient use of resources in tracking the delivery item, while allowing the customer to track the delivery item using the item's unique identifier.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for tracking a delivery item, comprising:
a delivery fee indicator affixed to the delivery item and including a unique identifier;
delivery processing equipment that processes the delivery item, the delivery processing equipment comprising:
a reader that reads the unique identifier during processing of the delivery item; and
a signal generator that transmits a status signal containing the unique identifier and status information regarding a processing status of the delivery item;
a database that receives the status signal and stores the status information together with the unique identifier; and
a query system that receives a customer-generated status inquiry including the unique identifier, queries the database to retrieve the status information using the unique identifier, and transmits the status information to the customer.

2. The system of claim 1, wherein the delivery fee indicator comprises a postage stamp.

3. The system of claim 2, wherein the unique identifier is a barcode.

4. The system of claim 2, wherein the unique identifier is a two-dimensional barcode.

5. A method for tracking a delivery item having an affixed delivery fee indicator that includes a unique identifier, the method comprising:
processing the delivery item with delivery processing equipment;
reading the unique identifier from the delivery fee indicator as the item is processed;
generating status information regarding a processing status of the item;
updating a database that stores the status information together with the unique identifier;
receiving a customer status inquiry including the unique identifier; and
supplying the status information to the customer.

6. The system of claim 5, wherein the unique identifier is a barcode.

7. The system of claim 5, wherein the unique identifier is a two-dimensional barcode.

8. A system for tracking a delivery item with a delivery fee indicator having a unique identifier, comprising:
a container having a unique identifier into which the delivery item is placed;
delivery processing equipment that processes the container, the delivery processing equipment comprising:
a reader that reads the container unique identifier during processing of the container; and
a signal generator that transmits a status signal including the container unique identifier and status information regarding a processing status of the container; and
a database that associates the delivery item unique identifier with the container unique identifier, and receives the status signal and stores the information regarding a processing status of the mail container,
a query system that receives a customer-generated status inquiry including the delivery item unique identifier, queries the database to retrieve the processing status information using the delivery item unique identifier, and transmits the status information to the customer.

9. The system of claim 9, wherein the container unique identifier is a barcode.

10. The system of claim 8, wherein the container unique identifier is a two-dimensional barcode.

11. The system of claim 8, wherein the container unique identifier includes a radio-frequency identification.
